(19) United States
(12) Patent Application Publication
(10) Pub. No.: US 2026/0219559 A1
(43) Pub. Date: Jul. 30, 2026

(54) IMAGE CAPTURE APPARATUS, CONTROL METHOD FOR IMAGE CAPTURE APPARATUS, AND STORAGE MEDIUM

(71) Applicant: CANON KABUSHIKI KAISHA, Tokyo (JP)

(72) Inventors: NOBUSHIGE WAKAMATSU, Tokyo (JP); RIE MYOJIN, Tokyo (JP); KIYOTO UEDA, Tokyo (JP)

(21) Appl. No.: 19/451,611

(22) Filed: Jan. 16, 2026

(30) Foreign Application Priority Data
Jan. 27, 2025 (JP) 2025-011657

(51) Int. Cl. G03B 17/56; H04N 23/695

(52) U.S. Cl. CPC G03B 17/561; H04N 23/695

(57) ABSTRACT

An image capture apparatus comprising: an image capture unit that captures an image of a subject; a support unit that supports the image capture unit; a gimbal unit that connects the image capture unit and the support unit and can control tracking of the image capture unit relative to movement of the support unit; one or more memory devices that store a set of instructions; and one or more processors that execute the set of instructions to: automatically set a predetermined control mode from among a plurality of control modes for controlling the tracking.

### BACKGROUND

### Field of the Technology

The present disclosure relates to an image capture apparatus, a control method for an image capture apparatus, and a storage medium.

### Description of the Related Art

The use of a gimbal while capturing images with a camera is widely known as a technique that enables vibrations from walking or a vehicle to be effectively suppressed and smooth video to be captured. Cameras that use a gimbal to provide high quality image capture in an easy and convenient manner to the user have also been developed. With such a camera, control of movement of the image capture unit of the camera relative to movement of the grip of the camera (hereinafter also referred to as the gimbal control mode) can be changed by the user according to the image capturing scene to obtain an optimal gimbal effect for the image capturing scene. Note that gimbal control modes include, for example, a lock mode in which the image capture direction does not follow movement of the grip of the camera during image capture, and variation in the image capture direction is suppressed, and also a follow mode in which the image capture direction follows movement of the grip during image capture. Also, a method for switching between different gimbal control modes is described in Japanese Patent Gazette Laid-open No. 2021-508067.

In order to effectively use a gimbal according to the image capturing scene, the user needs to know the characteristics of the gimbal and immediately determine and set the optimal gimbal control mode for each scene. However, such setting is burdensome for the user. Also, scene-specific settings include very detailed settings such as gimbal sensitivity settings for setting the level of tracking of the image capture direction relative to the orientation of the grip and gimbal tracking settings for tracking a subject, and configuring such settings is burdensome for the user. Also, in the case of switching the gimbal control mode, the user performs such switching manually. Such an operation also puts a lot of burden on the user, and as a result, there is a possibility that the user may miss an image capturing scene.

### SUMMARY

The present disclosure enables realization of a novel mechanism that can reduce the burden on a user relating to selecting a gimbal control mode for an image capture apparatus.

One aspect of the present disclosure provides an image capture apparatus comprising: an image capture unit that captures an image of a subject; a support unit that supports the image capture unit; a gimbal unit that connects the image capture unit and the support unit and can control tracking of the image capture unit relative to movement of the support unit; one or more memory devices that store a set of instructions; and one or more processors that execute the set of instructions to: automatically set a predetermined control mode from among a plurality of control modes for controlling the tracking.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are schematic views of an image capture apparatus according to an embodiment.

FIG. 2 is a diagram illustrating a block configuration of an image capture apparatus according to an embodiment.

FIG. 3 is a block and line diagram of gimbal control according to an embodiment.

FIG. 4 is a flowchart illustrating a processing process according to an embodiment.

FIGS. 5A and 5B are diagrams illustrating display screens according to an embodiment.

FIG. 6 is a flowchart illustrating a processing process according to an embodiment.

FIG. 7 is a flowchart illustrating a processing process according to an embodiment.

FIG. 8 is a flowchart illustrating a processing process according to an embodiment.

FIG. 9 is a table illustrating gimbal settings according to an embodiment.

FIG. 10 is a table illustrating gimbal settings according to an embodiment.

FIG. 11 is a diagram for describing motion vector detection according to an embodiment.

FIGS. 12A and 12B are diagrams for describing gimbal tracking according to an embodiment.

FIG. 13 is a diagram for describing gimbal tracking settings for camera work according to an embodiment.

FIGS. 14A, 14B, and 14C are diagrams illustrating display screens according to an embodiment.

FIGS. 15A and 15B are diagrams illustrating display screens according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Hereinafter, a front-rear direction indicates a horizontal direction from a grip unit 102 toward a subject in a case where the orientation of a camera unit 101 is in a normal position. Note that the normal position indicates a state in which a camera lens faces a direction parallel with a direction perpendicular to the gravity direction, with the bottom portion of the camera facing down. Also, a left-right direction indicates a horizontal direction orthogonal to the front-rear direction. An up-down direction indicates a direction (vertical direction) orthogonal to both the front-rear direction and the left-right direction.

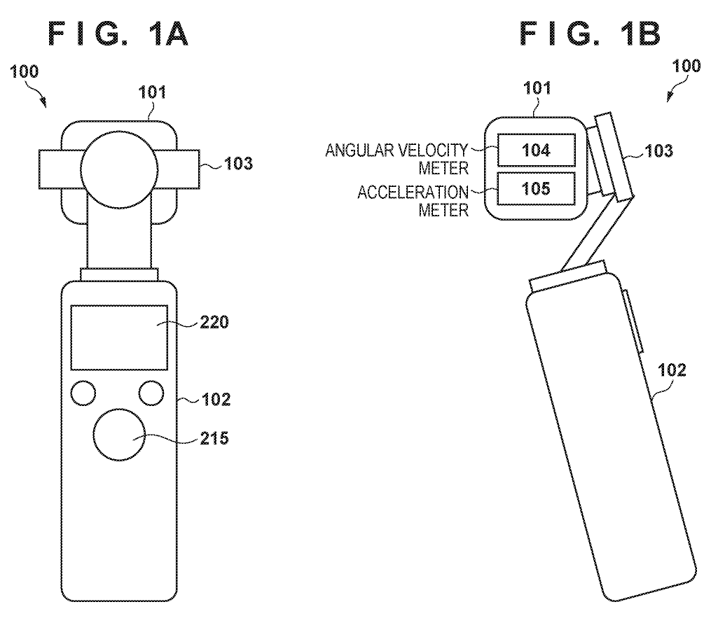

An overview of a camera 100 with an integrally formed gimbal mechanism (hereinafter also referred to as a gimbal camera) according to some embodiments will be described using FIGS. 1A and 1B. FIG. 1A illustrates an example of a back view of the gimbal camera 100. FIG. 1B illustrates an example of a side view of the gimbal camera 100. The gimbal camera 100 includes the camera unit 101, the grip unit 102, a gimbal unit 103, and an angular velocity meter (gyro sensor) 104 and an acceleration meter (acceleration sensor) 105 described below. Note that the camera unit 101 is an example of an “image capture unit”. Also, the grip unit 102 is an example of a “support unit configured to support an image capture unit”. The gimbal unit 103 is an example of a “gimbal unit that can control tracking of the image capture unit”.

The camera unit 101 includes the angular velocity meter 104 and the acceleration meter 105 for detecting shaking of the image capture unit and the apparatuses in the gimbal camera 100. The grip unit 102 is a body portion of the gimbal camera 100 that is gripped by the user. The grip unit 102 is provided with an operation unit 215, a display unit 220, and the like. The gimbal unit 103 is provided to connect the camera unit 101 and the grip unit 102. The gimbal unit 103 includes rotation mechanisms including a motor (hereinafter also referred to as a gimbal motor) that can independently rotate about three axes, with the three orthogonal axes of roll, pitch, and yaw corresponding to the rotation axes, and an arm unit connecting each of the rotation mechanisms. The gimbal unit 103 prevents inertial force produced by the mechanical mechanisms in the grip unit 102 to travel to the camera unit 101 via shaking of the grip unit 102. The angular velocity meter 104 and the acceleration meter 105 each detect rotational movement and translation movement of the camera unit 101. Also, the gimbal motor is driven so that the detected movements cancel out each other. According to this gimbal camera 100, shaking of the grip unit 102 travelling to the camera unit 101 is suppressed, and as a result, a smooth video can be captured.

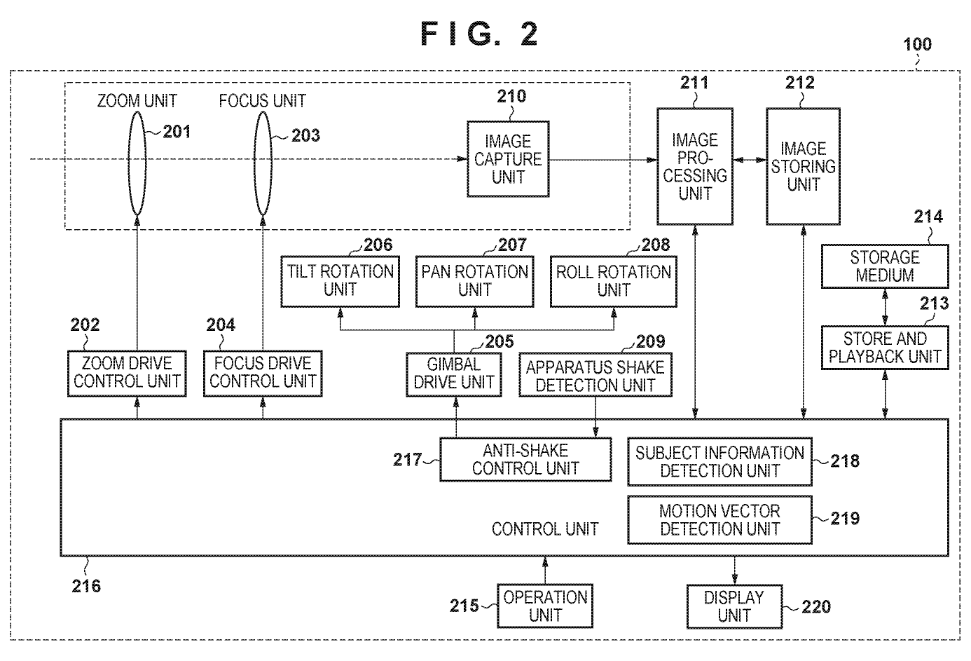

The blocks of the gimbal camera 100 will now be described using FIG. 2. The gimbal camera 100 includes a control unit 216. The control unit 216, for example, includes a CPU (MPU) and a memory (DRAM, SRAM, or non-volatile memory (EEPROM)). Also, the CPU controls each block of the gimbal camera 100 by executing various types of processing (programs) and controls the data transfer between blocks.

Also the gimbal camera 100 includes a zoom unit 201 including a zoom lens for changing the magnification of the subject image formed by an image capture unit 210 and a zoom drive control unit 202 that controls the driving of the zoom unit 201. Also, the gimbal camera 100 includes a focus unit 203 including a lens for adjusting the focus of the subject image formed by the image capture unit 210 and a focus drive control unit 204 that controls the driving of the focus unit 203.

Also, the gimbal camera 100 includes the image capture unit 210, an image processing unit 211, and an image storing unit 212. A subject image incident via each lens group is formed on the image sensor of the image capture unit 210. Then, the image capture unit 210 performs A/D conversion of the analog image signal corresponding to the subject image formed on the image sensor and outputs the converted digital image data to the image processing unit 211. The image processing unit 211 applies distortion correction, white balance adjustment, color interpolation processing, and similar image processing to the received digital image data. Then, the image processing unit 211 outputs the post-correction-application digital image data. The image storing unit 212 converts the digital image data output from the image processing unit 211 into data with a format for storage such as the JPEG format and the MPEG format.

Also, the control unit 216 of the gimbal camera 100 includes a subject information detection unit 218 and a motion vector detection unit 219. The subject information detection unit 218 uses the image data output from the image processing unit 211 to obtain information of the position and size of the subject included in the screen showing the image data. With the motion vector detection unit 219, a “motion vector” of the subject in the screen is detected. A method of detecting a “motion vector” may include, for example, a method of dividing a screen into a plurality of regions, comparing an image of one frame previous stored in advance and the current image (two consecutive images) with one another to obtain relative position difference information of the subject and calculate a motion amount of the image. In this manner, the control unit 216 obtains subject detection information and motion vector detection information as detection information from the image.

Also, the gimbal unit 103 of the gimbal camera 100 includes a tilt rotation unit 206, a pan rotation unit 207, a roll rotation unit 208, and a gimbal drive unit 205 that rotates these rotation units. Note that the tilt rotation unit 206 rotates the camera unit 101 in the tilt direction. In a similar manner, the pan rotation unit 207 and the roll rotation unit 208 rotate the camera unit 101 in the pan direction and the roll direction, respectively.

Also, the gimbal camera 100 includes an apparatus shake detection unit 209 and an anti-shake control unit 217. The apparatus shake detection unit 209 includes the angular velocity meter 104 and the acceleration meter 105 described above. The angular velocity meter 104 can detect the angular velocity of rotational movement about the three axes (tilt, pan, and roll) of the camera unit 101. Also, the acceleration meter 105 can detect acceleration of translation movement along the direction of the three axes of the camera unit 101. The anti-shake control unit 217 calculates the shake amount in the tilt direction, the pan direction, and the roll direction using signals detected by the apparatus shake detection unit 209. Also, the anti-shake control unit 217 calculates the correction direction and correction amount for the shake. The anti-shake control unit 217 inputs, to the gimbal drive unit 205, a command to drive the tilt rotation unit 206, the pan rotation unit 207, and the roll rotation unit 208 according to the correction direction and the correction amount. Also, the gimbal drive unit 205 drives the tilt rotation unit 206, the pan rotation unit 207, and the roll rotation unit 208 according to this command. In this manner, the shake or tilt of the camera unit 101 can be corrected.

Also, the gimbal camera 100 includes the operation unit 215 for operating the system, a store and playback unit 213, and the display unit 220. The operation unit 215 includes a power button and a button or the like for triggering image capture by the image capture apparatus. When the power button is operated, power is supplied to the entire system in accordance with the intended use and the gimbal camera 100 is activated.

The store and playback unit 213 stores compressed image signals generated by the image processing unit 211 in a storage medium 214. The storage medium 214 may be a storage medium built into the gimbal camera 100 or may be a detachable storage medium. The storage medium 214 can store various types of data including generated compressed image signals, compressed audio signals, audio signals, and the like. The display unit 220 includes a display apparatus that displays images and characters. Note that the display unit 220 is a liquid crystal display, for example. Also, the display unit 220 may be a touch screen with touch-input functionality, for example. In a case where the display unit 220 is a touch screen, a portion of the functions of the operation unit 215 may be handled by the display unit 220.

### Gimbal Anti-shake Processing

Next, gimbal anti-shake processing will be described. In describing the gimbal anti-shake processing, first, a gimbal control method will be described. The gimbal control method includes a follow mode corresponding to a first control mode and a lock mode corresponding to a second control mode. In these control modes, detection information is output at a high-speed sampling period from the angular velocity meter 104 and the acceleration meter 105 provided in the camera unit 101. Also, using the output detection information, the rotational driving of the motor provided in the rotation mechanism of the gimbal unit 103 is feedback-controlled. In this manner, vibrations in the camera unit 101 are suppressed.

Specifically, the follow mode is a control mode in which vibrations in the grip unit 102 are suppressed and shaking of the camera unit 101 is reduced, for example. Also, the follow mode is a control mode in which the orientation of the camera unit 101 is caused to conform to the direction that the grip unit 102 is facing. Thus, when the state of the camera unit 101 is one in which the shaking has settled, the orientation of the grip unit 102 and the camera unit 101 are substantially aligned. Specifically, the apparatus shake detection unit 209 detects the rotation angle of the gimbal motor via a motor encoder. Then, in a case where the motor rotation angle is greater than a predetermined value, that is, there is a large deviation from the reference direction, the anti-shake control unit 217 adds a control correction amount to the normal control amount for the camera unit 101 to move the orientation of the camera unit 101 to the reference position direction of the grip unit 102. By performing such anti-shake control, the camera unit 101 can be caused to track the direction the grip unit 102 is facing.

Here, when the control correction amount is large, the delay in tracking to the reference position of the camera unit 101 for the grip unit 102 is small, but the anti-shake control performance is reduced. On the other hand, when the control correction amount is small, the delay in tracking to the reference position of the camera unit 101 for the grip unit 102 is large, but high anti-shake control performance can be achieved. Here, such a delay is represented by gimbal sensitivity. In other words, in a case where the delay of the tracking to the reference position of the camera unit 101 is small with respect to the movement of the grip unit 102, the gimbal sensitivity is high. However, in a case where the delay of the tracking to the reference position of the camera unit 101 is large with respect to the movement of the grip unit 102, the gimbal sensitivity is low.

Also, the CPU uses the display unit 220 to display a screen that allows the user to change the settings to increase the tracking performance of the camera unit 101 with respect to the movement of the grip unit 102 or increase the anti-shake performance of the camera unit 101. In this manner, an appropriate gimbal sensitivity can be set for each image capturing scene. Note that the follow mode is suited to a scene such as one in which a moving subject is captured while being tracked from behind.

The lock mode is a control mode in which vibrations in the grip unit 102 are suppressed as much as possible and shaking of the camera unit 101 is reduced, for example. Also, the lock mode is a control mode in which the orientation of the camera unit 101 is not changed even when the grip unit 102 is moved, for example. With such a lock mode, the camera unit 101 maintains the same image capture direction. The lock mode is suited to a scene such as one in which the image capture direction of the camera unit 101 is maintained in a certain direction, for example. In the case of the lock mode, to maintain the absolute angle position of the camera unit 101, the absolute angle in a spatial coordinate system is calculated. Such a method includes detecting the camera attitude angles via an acceleration sensor and detecting the azimuth angle via a geomagnetic sensor. Also, the anti-shake control unit 217 calculates an angle for anti-shake control by performing sensor fusion with these detection values and a detection value of an angular velocity meter with excellent detection accuracy with respect to high frequency components. By performing such gimbal anti-shake control, control of the image capture direction of the camera unit 101 while in the lock mode can be implemented.

Also, the control unit 216 uses the display unit 220 to display a screen for allowing the user to change the settings for whether to perform control in the follow mode or the lock mode in regards to the tilt, pan, and roll axes. Via such a screen, an appropriate gimbal image capture effect for each image capturing scene can be achieved.

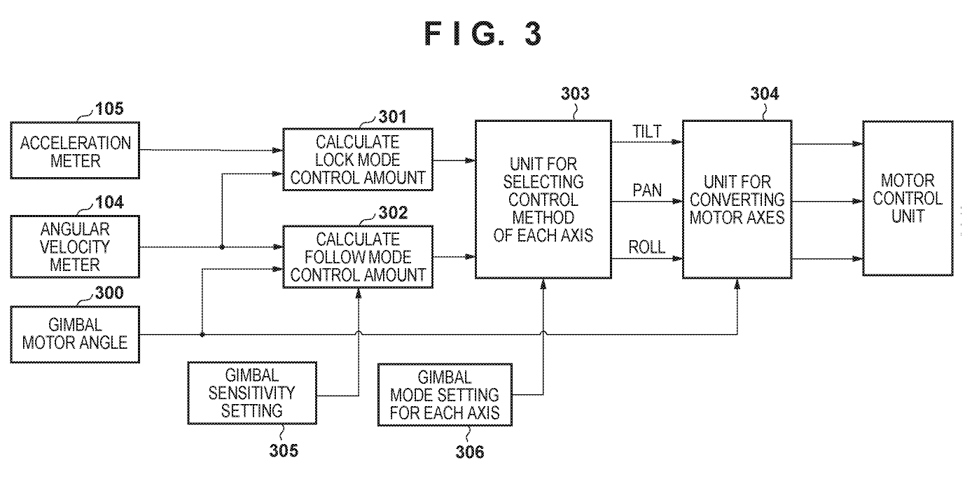

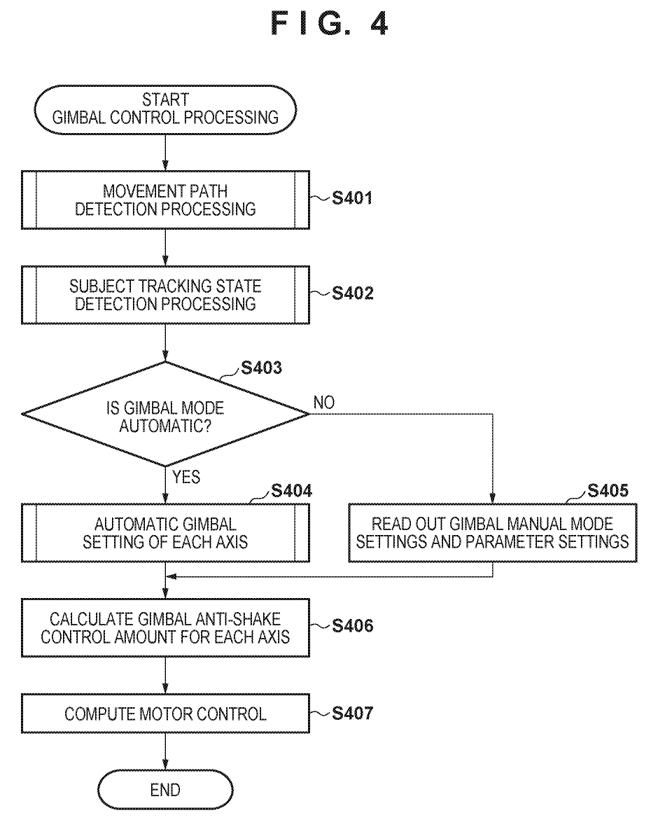

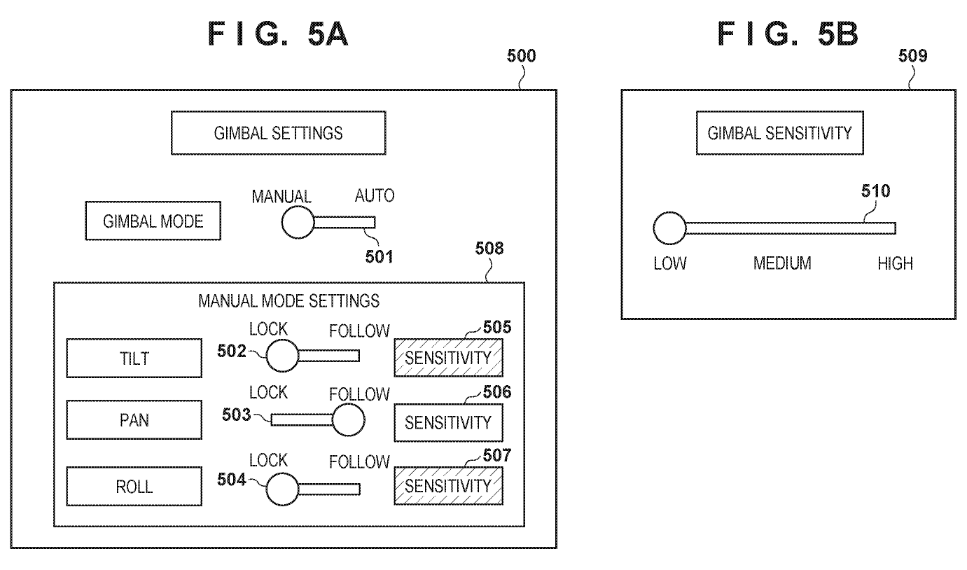

Next, the gimbal control processing will be described using FIGS. 3 to 5A and 5B. FIG. 3 illustrates an example of a block diagram of gimbal control. FIG. 4 illustrates an example of a flowchart of the gimbal control processing. FIGS. 5A and 5B illustrate examples of gimbal control settings screens. Note that the processing illustrated in FIG. 4 is implemented by a CPU reading out a program stored in an EEPROM to an SRAM or a DRAM and executing the program.

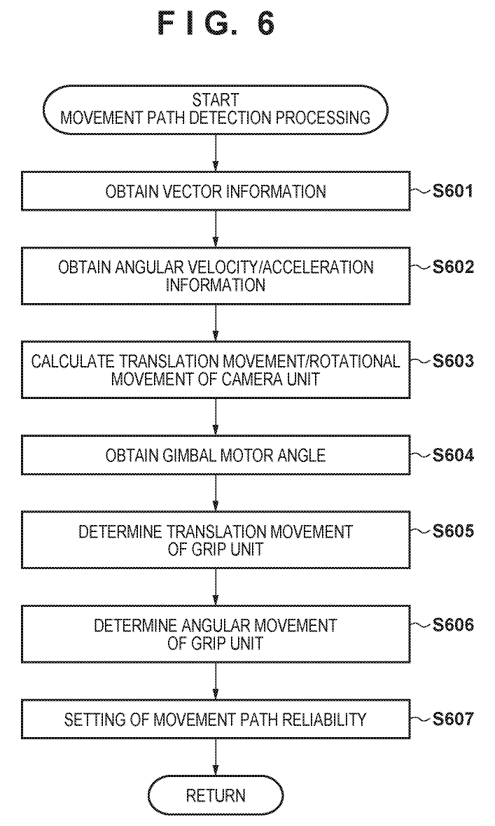

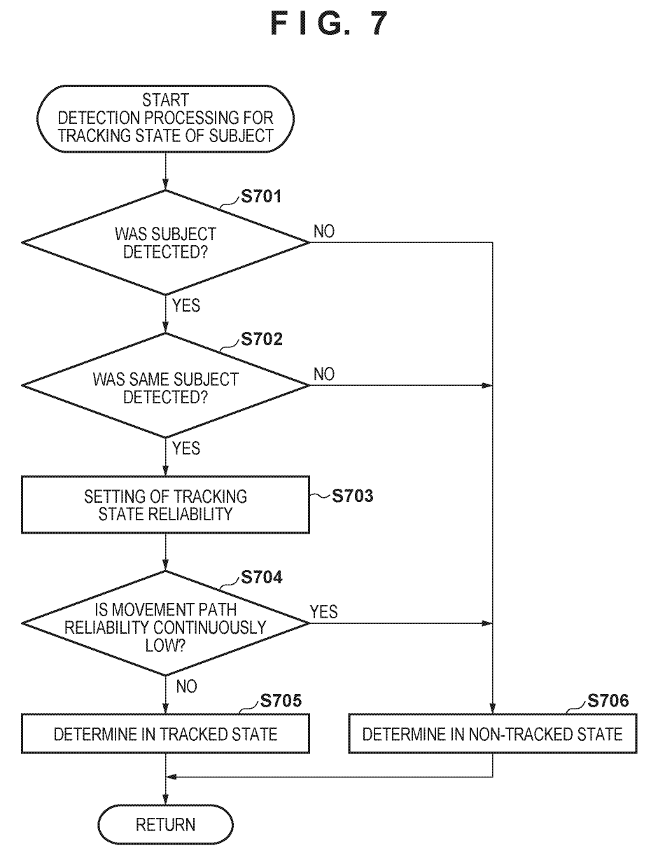

In S401 of FIG. 4, a CPU (an example of a “first detection unit”) executes detection processing of the movement path of the grip unit 102. The movement path detection processing will be described below using the flowchart of FIG. 6. Then, a CPU (an example of a “second detection unit”) executes a determination of the translation movement and a determination of the angular movement (rotational movement) of the camera unit 101. In S402, the CPU executes detection processing of the tracking state of the subject. The subject track state detection processing will be described below using the flowchart of FIG. 7. In S403, the CPU determines whether the gimbal mode is set to an auto mode or set to a manual mode. The auto mode is a mode in which the gimbal control mode is automatically set. The manual mode is a mode in which the gimbal control mode is set manually (by a user selection operation). Then, in a case where the gimbal mode is determined by the CPU to be set to the auto mode, the processing advances to S404. In a case where the gimbal mode is determined by the CPU to be set to the manual mode, the processing advances to S405.

Note that regarding the gimbal mode setting method, the CPU displays a gimbal settings screen 500 such as that illustrated in FIG. 5A on the display unit 220 (a touch panel in this example). The gimbal settings screen 500 displays an object 501 that allows the manual mode or the auto mode to be selected for the gimbal mode. The CPU can set the gimbal mode to the manual mode or the auto mode by a gimbal mode selection operation being received on the gimbal settings screen 500.

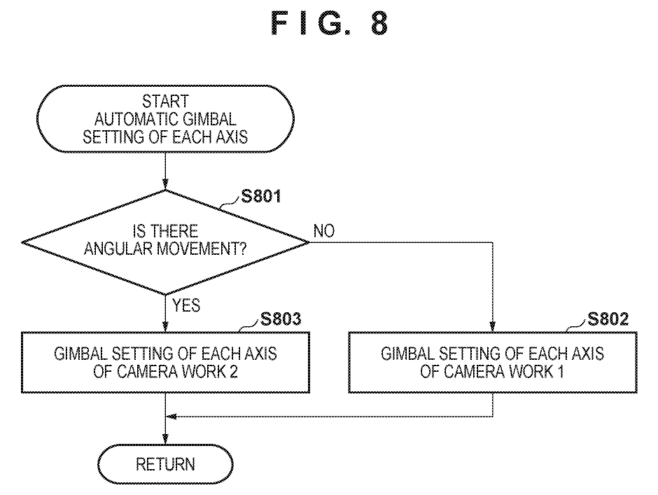

In S403, in a case where the CPU determines that the gimbal mode is set to the auto mode, in S404, the CPU executes the following processing. In other words, the CPU uses the determination result of each of the translation movement and the camera angular movement of the camera unit 101 determined in S401 and S402 to automatically execute the gimbal settings for each of the tilt, pan, and roll axes. The setting method will be described below using the flowchart of FIG. 8. Then, the processing advances to S406. Note that the gimbal settings refer to the gimbal control mode settings and the settings for a control parameter in this mode.

In a case where the CPU determines that the gimbal mode is set to the manual mode in S403, the CPU receives a selection operation on the gimbal settings screen 500 illustrated in FIG. 5A and executes the gimbal settings for each axis. Specifically, the gimbal settings screen 500 includes a manual mode setting portion 508 that can be operated in a case where manual is selected for the gimbal mode. Also, the manual mode setting portion 508 includes objects 502 to 504 that allow the lock mode or the follow mode to be selected for the gimbal control mode for each of the tilt, pan, and roll axes. Also, the manual mode setting portion 508 includes objects 505 to 507 that allow the gimbal sensitivity to be selected in a case where the follow mode is selected for the gimbal control mode for each of the tilt, pan, and roll axes.

Also, in a case where selection of one of the objects 505 to 507 is received, the CPU displays a gimbal sensitivity settings screen 509 as illustrated in FIG. 5B. The gimbal sensitivity settings screen 509 includes a bar 510 that allows selection of three levels, low, mid, and high, for the gimbal sensitivity, for example. The CPU receives a selection operation of the manual mode setting portion 508 of the gimbal settings screen 500 and of the bar 510 of the gimbal sensitivity settings screen 509 and sets the gimbal control mode for each axis and the gimbal sensitivity for the follow mode. Then, the processing advances to S406.

In S406, the CPU calculates the gimbal anti-shake control amount for each axis. The calculation method for the gimbal anti-shake control amount will now be described using FIG. 3. First, in block 301, the CPU calculates the control amount for the lock mode using the output of the acceleration meter 105 and the output of the angular velocity meter 104. In block 302, the CPU calculates the control amount for the follow mode using the output of the angular velocity meter 104, a gimbal motor angle 300, and a gimbal sensitivity setting value 305 selected on the gimbal sensitivity settings screen 509 of FIG. 5B.

In block 303, the CPU detects the gimbal control mode set for each axis. Then, the CPU calculates the gimbal anti-shake control amount for each axis with the imaging plane as the reference for each gimbal control mode. In this calculation, the lock mode control amount and the follow mode control amount for each of the tilt, pan, and roll axes, and a gimbal sensitivity 306 selected on the gimbal settings screen 500 of FIG. 5A may be used. In block 304, the CPU uses the gimbal anti-shake control amount for each axis calculated in block 303 and the gimbal motor angle 300 for each axis to convert the gimbal anti-shake control amount to a control amount with each motor axis as a reference.

Now we will return to the description of the flowchart of FIG. 4. When the CPU converts the gimbal anti-shake control amount in such a manner, the processing advances to S407. In S407, the CPU uses the gimbal anti-shake control amount for each axis to perform gimbal motor control computations for driving the tilt rotation unit 206, the pan rotation unit 207, and the roll rotation unit 208. Then, the CPU executes gimbal anti-shake by driving the motor for each axis using the computation results. Then, the CPU ends the processing and is put in a wait state for waiting to execute the next cycle processing.

### Movement Path Detection Processing

The detection processing of the movement path of the grip unit 102 in S401 of FIG. 4 will now be described using FIG. 6. Note that the present processing is implemented by a CPU reading out a program stored in an EEPROM to an SRAM or a DRAM and executing the program.

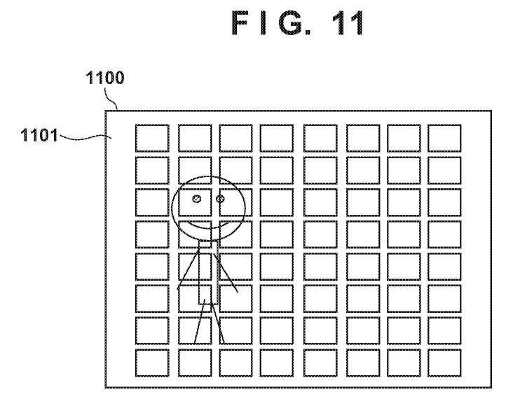

In S601, the CPU obtains the motion vector information of the subject. Specifically, for example, as illustrated in FIG. 11, the CPU in advance sets the section to be detected for a motion vector to a plurality of fixed positions 1101 on a screen 1100 showing captured image data. Then, the CPU obtains the image frames consecutively captured by the camera unit 101 and stores each frame in the memory as time-consecutive image data. Then, the CPU calculates the displacement of the brightness of each pixel included in each fixed position 1101 across consecutive frames. Then, the CPU uses the calculated displacement vector to detect the movement direction and speed of the subject of each fixed position 1101. The CPU detects the movement direction and speed detected in this manner as a motion vector. In other words, in this detection method, a motion vector is a movement vector of the brightness of pixels across image frames in a specific region of an image frame.

Alternatively, as another motion vector detection method, the CPU may automatically extract a feature point and automatically determine a motion vector detection position. In other words, for example, a method such as Scale-Invariant Feature Transform (SIFT), Speeded-Up Robust Features (SURF), or the like may be used to automatically extract a feature point from each image frame. Then, the CPU may perform matching of the extracted feature point across consecutive frames and detect a motion vector from the change in position of the matched feature point.

In S602, the CPU obtains the output of the angular velocity meter 104 and the output of the acceleration meter 105. In S603, the CPU performs a calculation of the translation movement direction and translation movement amount of the camera unit 101 and the rotational movement direction and rotational movement amount. As the method of calculating the translation movement amount and the rotation amount of the camera unit 101, there are some methods of performing sensor fusion of the output of the motion vector, the angular velocity, and the acceleration obtained from the captured image. In an example method, a Kalman filter is used to calculate the translation movement amount and the rotation amount of the camera unit 101 via a linear model. In another example method, an extended Kalman filter is used to calculate the translation movement amount and the rotation amount of the camera unit 101 from a nonlinear state transition model.

In yet another calculation method, computer vision and the output data from an angular velocity sensor and an acceleration sensor are used. In another example, the CPU may track a feature point across consecutive image frames via Visual-Inertial Odometry (VIO), calculate a motion vector, and use the angular velocity output and the acceleration output to correct the movement of the feature point. In yet another example, the CPU may estimate the position and orientation of the camera unit 101, use bundle adjustment and sliding window optimization to optimize the overall position and orientation, and calculate the translation movement amount and the rotation amount of the camera unit 101.

In another example, the CPU may extract an image feature point via Simultaneous Localization and Mapping (SLAM), generate a map, track the position of the feature point, and calculate a motion vector. In yet another example, the CPU may use the angular velocity output and the acceleration output, correct the movement of the feature point, estimate the position and orientation of the camera unit 101, add a new feature point, and update the map. Also, the CPU may calculate the translation movement amount and the rotation amount of the camera unit 101 by continuously updating the estimate of the position and orientation. In this manner, via any one of these methods, the CPU calculates the translation movement amount and the rotation amount of the camera unit 101.

In S604, the CPU obtains angle information of the gimbal motor. In S605, the CPU performs a determination of the translation movement of the grip unit 102. Specifically, the CPU executes axes transformation processing using the translation movement amount and the rotation amount of the camera unit 101 calculated in S603 and the gimbal motor angle to calculate the translation movement amount and the rotation amount of the grip unit 102. Then, the CPU uses the calculated translation movement amount to determine whether or not translation movement in a specific direction is continuing and uses this determination result to determine the translation movement of the grip unit 102. Here, determination is performed for forward movement, backward movement, left movement, right movement, upward movement, downward movement, and no movement.

In S606, the CPU performs a determination of the angular movement of the grip unit 102. In other words, the CPU uses the rotation amount of the grip unit 102 calculated in S605 to determine whether the rotational movement of the grip unit 102 is continuing in a specific direction and uses this determination result to determine the angular movement of the grip unit 102. Here, the tilt movement, pan movement, pan and tilt movement, and no movement are determined, and in a case where each movement is continued, each movement determination is performed.

In S607, the CPU performs setting of the movement path reliability. The translation movement/rotation detection processing described above is processing premised on the motion vector of a subject in a captured image being able to be obtained. However, there are some cases where, due to effects such as blurring due to brightness or movement of the gimbal camera 100, the number of motion vectors that can be obtained are very few. In such a case, there is a possibility of performing a false determination in the translation movement and rotation determination due to moving body vector effects, vector effects to concentrated at a specific section, and the like.

Here, the CPU uses the number of vectors already detected, the distribution of subject positions in an image region, and the like to calculate the movement path reliability and use it in the processing described below. The CPU, for example, sets the movement path reliability to high in a case where the number of vectors is large and sets the movement path reliability to low in a case where the number of vectors is small. Also, in a case where the vectors are concentrated in a specific region of the image and are sparse in another region, the CPU sets the movement path reliability to low, and in a case where vectors can be obtained evenly throughout the entire image region, the CPU sets the movement path reliability to high. Then, the processing advances to S402 of FIG. 4. In this manner, determination is executed for the translation movement and the angular movement of the grip unit 102.

### Subject Tracking State Detection Processing

The subject tracking state detection processing of S402 of FIG. 4 will now be described in detail using FIG. 7. Note that the present processing is implemented by a CPU reading out a program stored in an EEPROM to an SRAM or a DRAM and executing the program.

In S701, the CPU determines whether or not the subject has been detected. Here, in a case where a person with a size that is equal to or greater than a predetermined size is detected, for example, a yes for detection is determined. Also, the CPU may perform object recognition in a specified region such as in a central region of the screen showing the captured image data. In a case where the CPU has detected a person or object, the processing advances to S702. Otherwise, the processing advances to S706.

In S702, the CPU determines whether or not the subject detected in S701 is the same as a previously detected subject. Specifically, in a case where the detected subject is a person, the CPU determines whether or not the person matches a subject detected up until the previous time. Also, in a case where the CPU determines that they do not match, the CPU provides a new ID to the subject and stores this in the memory. Also, in a case where the subject is an object, the CPU determines whether or not the subject is the same as an object previously detected in the region where the object was recognized. Then, in a case where it is determined that they do not match, the CPU provides a new ID to the objects and stores this in the memory. In a case where the CPU determines that the same subject is detected, the processing advances to S703. Otherwise, the processing advances to S706.

In S703, the CPU determines the reliability of the tracking state. Specifically, such a reliability determination is performed using a matching degree indicating whether or not the same subject is consecutively detected in time series. The matching degree may be calculated by a method in which an object detection model using a convolutional neural network (CNN) is used to detect a subject in images consecutive in time series and the detected subject is tracked. Alternatively, the matching degree may be calculated using SIFT, SURF, or a similar algorithm to extract a feature point in an image and match feature points across consecutive images. The matching degree may also be calculated by a method in which similarity between a specific template image and an input image is calculated.

Then, in a case where the calculated matching degree is low, the CPU sets the tracking state reliability to low, and in a case where the calculated matching degree is high, the CPU sets the tracking state reliability to high. Also, the CPU counts the number of detections of the same subject in a period a previous predetermined amount of time back from the current time. Then, if the number of detections is low, the CPU sets the tracking state reliability to low, and if the number of detections is high, the CPU sets the tracking state reliability to high. Accordingly, processing described below of whether or not the current tracking state is reliable information can be used.

In S704, the CPU calculates the movement path reliability in a similar manner to the processing of S607. Then, the CPU determines whether or not the movement path reliability is continuously low. In a case where the detection reliability is continuously low, the processing advances to S706. Otherwise, the processing advances to S705. In S706, the CPU determines that the subject is in a non-tracked state, and the processing advances to S403 of FIG. 4. On the other hand, in S705, the CPU determines that the subject is in a tracked state, and the processing advances to S403 of FIG. 4. Via the method described above, the tracking state of the subject is detected. Note that S704 and S705 correspond to an example of “uses the detection result of a first detection unit to detect the tracking state of the subject by the image capture unit”.

### Automatic Setting of each Gimbal Setting

The processing for automatically performing the gimbal setting for each of the tilt, pan, and roll axes, in S404 of FIG. 4 will now be described in detail using FIG. 8. Note that the present processing is implemented by a CPU reading out a program stored in an EEPROM to an SRAM or a DRAM and executing the program.

In S801, the CPU (an example of a “first determination unit”) uses the determination result of the angular movement of the grip unit 102 determined in S606 of FIG. 6 to determine whether or not there is consecutive angular movement of the grip unit 102 in a certain direction. In a case where the CPU determines that there is angular movement, the processing advances to S803. Otherwise, the processing advances to S802. Note that hereinafter, camera work in the case of angular movement will be referred to as camera work 2 and camera work in the case of no angular movement will be referred to as camera work 1.

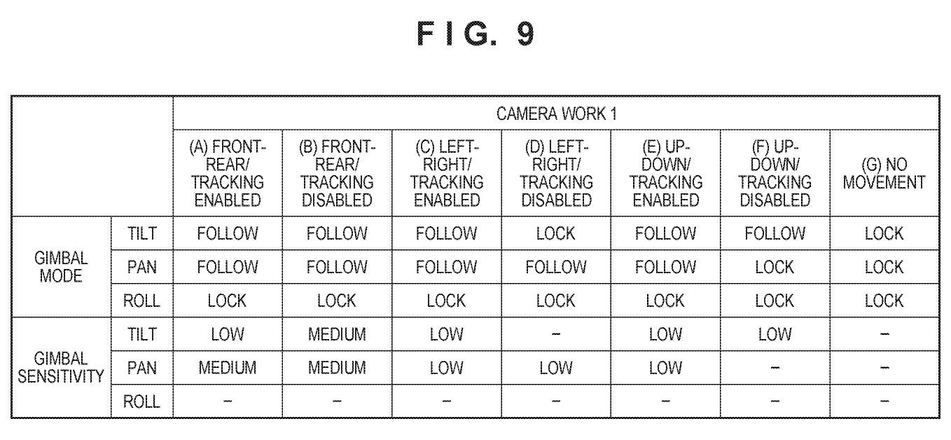

In S802, the CPU automatically performs the gimbal setting for each axis in the case of translation movement. The gimbal setting of each axis of camera work 1 will be described using FIG. 9. Note that the table of FIG. 9 illustrates examples of settings when the orientation of the camera unit 101 is the normal position (a state in which the camera lens faces at or near a direction perpendicular to the gravity direction and the bottom portion of the camera faces down). Note that if the camera orientation is the portrait orientation (a state in which the bottom portion of the camera faces horizontal or upward with respect to the ground), the tilt and pan axes settings are reversed.

(A) In a case where the CPU (an example of a “second determination unit”) determines that the direction of the translation movement of the grip unit 102 is front-rear movement and the CPU determines that the state is a subject tracking enabled state, the tilt gimbal mode is set to the follow mode and the tilt gimbal sensitivity is set to low. Also, the CPU sets the pan gimbal mode to the follow mode and the pan gimbal sensitivity to medium.

Specifically, in the case of front-rear movement, the roll direction is preferably maintained at an angle with a direction perpendicular to the gravitational force as a reference. Here, the CPU sets the gimbal mode for the roll direction to the lock mode. Since the CPU has determined that subject tracking is enabled, it is expected that the user is capturing images of a subject while tracking the subject. Here, to make it easier for the user to track the subject, the CPU sets the gimbal mode for both tilt and pan to the follow mode. Also, it is expected that there will be few scenes in which the subject moves greatly in the up-down direction and many scenes in which the subject moves greatly in the left-right direction. Regarding this, the CPU increases the anti-shake about the tilt axis by setting the tilt gimbal sensitivity to low. On the other hand, the CPU increases the degree of tracking of the camera unit 101 with respect to the rotation of the grip unit 102 about the pan axis by setting the pan gimbal sensitivity to medium. Such a setting is illustrated in column (A) of the table of FIG. 9.

(B) In a case where the CPU determines that the direction of the translation movement of the grip unit 102 is front-rear movement and the CPU determines that the state is a subject tracking disabled state, the tilt gimbal mode is set to the follow mode and the tilt gimbal sensitivity is set to medium. Also, the CPU sets the pan gimbal mode to the follow mode and the pan gimbal sensitivity to medium.

Specifically, as with column (A), in the case of front-rear movement, the roll direction is preferably maintained at an angle with a direction perpendicular to the gravitational force as a reference. Here, the CPU sets the gimbal mode for the roll direction to the lock mode. On the other hand, in the case of front-rear movement with subject tracking disabled, it is expected that there are many scenes with the tilt direction also changing during image capture. Regarding this, as opposed to column (A), the CPU sets the tilt gimbal sensitivity to medium. In this manner, the degree of tracking of the camera unit 101 is increased also with respect to rotation about the tilt axis of the grip unit 102. Such a setting is illustrated in column (B) of the table of FIG. 9.

(C) In a case where the CPU determines that the direction of the translation movement of the grip unit 102 is left-right movement and the CPU determines that the state is a subject tracking enabled state, the tilt gimbal mode is set to the follow mode and the tilt gimbal sensitivity is set to low. Also, the CPU sets the pan gimbal mode to the follow mode and the pan gimbal sensitivity to low.

Specifically, in the case of left-right movement, the roll direction is preferably maintained at an angle with a direction perpendicular to the gravitational force as a reference. Here, the CPU sets the gimbal mode for the roll direction to the lock mode. Also, since subject tracking is enabled, it is expected that the user will capture images of a subject while tracking the subject. Here, to make it easier for the user to track the subject, the CPU sets the gimbal mode for both tilt and pan to the follow mode. Also, it is expected that there will be few scenes in which the subject moves greatly in the up-down and left-right direction. Regarding this, the CPU increases the anti-shake by setting the tilt and pan gimbal sensitivity to low. In this manner, enabling smooth video to be captured is prioritized. Such a setting is illustrated in column (C) of the table of FIG. 9.

(D) In a case where the CPU determines that the direction of the translation movement of the grip unit 102 is left-right movement and the CPU determines that the state is a subject tracking disabled state, the tilt gimbal mode is set to the lock mode. Also, the CPU sets the pan gimbal mode to the follow mode and the pan gimbal sensitivity to low. Also, the CPU sets the roll gimbal mode to the lock mode.

Specifically, in the case of left-right movement, the roll direction is preferably maintained at an angle with a direction perpendicular to the gravitational force as a reference. Here, the CPU sets the gimbal mode for the roll direction to the lock mode. Also, since subject tracking is disabled, the user preferably stably holds the camera unit 101 at a certain angle direction. Here, the CPU sets the tilt gimbal mode to the lock mode. Also, regarding the pan direction, it is expected that there are many scenes in which the user adjusts the pan direction with minor adjustments. Here, the CPU sets the pan gimbal mode to the follow mode, but sets the pan gimbal sensitivity to low to increase anti-shake. In this manner, enabling smooth video to be captured is prioritized. Such a setting is illustrated in column (D) of the table of FIG. 9.

(E) In a case where the CPU determines that the direction of the translation movement of the grip unit 102 is up-down movement and the CPU determines that the state is a subject tracking enabled state, the tilt gimbal mode is set to the follow mode and the tilt gimbal sensitivity is set to low. Also, the CPU sets the pan gimbal mode to the follow mode and the pan gimbal sensitivity to low. Also, the CPU sets the roll gimbal mode to the lock mode.

Specifically, in the case of up-down movement, the roll direction is preferably maintained at an angle with a direction perpendicular to the gravitational force as a reference. Here, the CPU sets the gimbal mode for the roll direction to the lock mode. In a case where subject tracking is enabled, it is expected that the user is capturing images of a subject while tracking the subject. Here, to make it easier for the user to track the subject, the CPU sets the gimbal mode for both tilt and pan to the follow mode. Also, it is expected that there will be few scenes in which the subject moves greatly in the up-down and left-right direction. Regarding this, the CPU increases the anti-shake by setting the tilt and pan gimbal sensitivity to low. In this manner, enabling smooth video to be captured is prioritized. Such a setting is illustrated in column (E) of the table of FIG. 9.

(F) In a case where the CPU determines that the direction of the translation movement of the grip unit 102 is up-down movement and the CPU determines that the state is a subject tracking disabled state, the tilt gimbal mode is set to the follow mode and the tilt gimbal sensitivity is set to low. Also, the CPU sets the gimbal mode for both pan and roll to the lock mode.

Specifically, in the case of forward movement, the roll direction is preferably maintained at an angle with a direction perpendicular to the gravitational force as a reference. Here, the CPU sets the gimbal mode for the roll direction to the lock mode. Also, since subject tracking is disabled, the user preferably stably holds the camera unit 101 at a certain angle direction. Here, the CPU sets the pan gimbal mode to the lock mode. Also, regarding the tilt direction, it is expected that there are many scenes in which the user adjusts the pan direction with minor adjustments. Here, the CPU sets the tilt gimbal mode to the follow mode, but sets the tilt gimbal sensitivity to low to increase anti-shake. In this manner, enabling smooth video to be captured is prioritized. Such a setting is illustrated in column (F) of the table of FIG. 9.

(G) In a case where the CPU determines that there is no translation movement of the grip unit 102, the CPU sets the gimbal mode for tilt, pan, and roll to the lock mode. This is because it is expected that there will be many scenes in which the user wishes to stop the camera unit 101 and capture images or in order to perform anti-shake control to suppress shake and tilting as much as possible. Such a setting is illustrated in column (G) of the table of FIG. 9.

Now we will return to the description of the flowchart of FIG. 8. Via the method described above, in S802, the CPU automatically performed gimbal setting of each axis. Then, the processing advances to S406 of the flowchart of FIG. 4.

In a case where the CPU determines that there is consecutive angular movement of the grip unit 102 in a certain direction in S801, in S803, the CPU automatically performs gimbal setting of each axis in the case of angular movement. Note that in S801, even in a case where translation movement is determined together with angular movement, the processing advances to S803. The processing flow indicates that anti-shake control corresponding to camera work produced by angular movement is prioritized in gimbal anti-shake. This is because, in a case where a regular angular movement operation is detected, there is an extremely high possibility that the user is capturing an image while intentionally operating the camera.

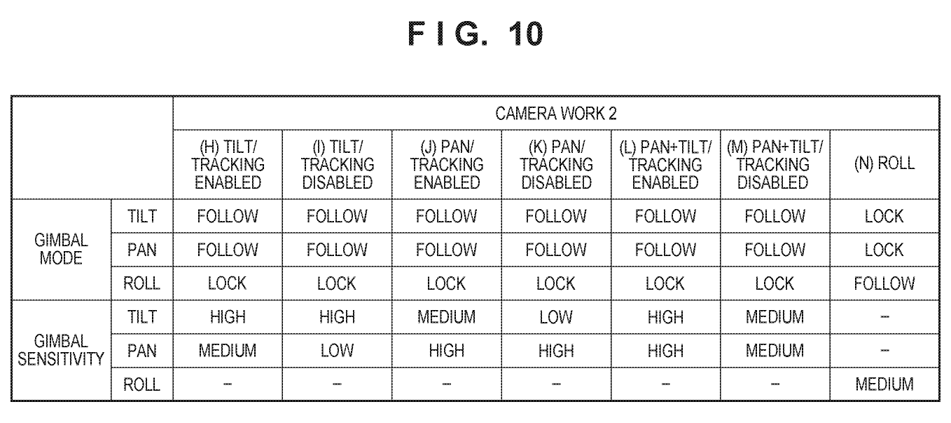

The gimbal setting of each axis of camera work 2 will be described using FIG. 10. Note that the table of FIG. 10 illustrates examples of settings when the orientation of the camera unit 101 is the normal position (a state in which the camera lens faces at or near a direction perpendicular to the gravity direction and the bottom portion of the camera faces down). Note that if the camera orientation is the portrait orientation (a state in which the bottom portion of the camera faces horizontal or upward with respect to the ground), the tilt and pan axes settings are reversed.

(H) In a case where the CPU determines that the angular movement of the grip unit 102 is tilt movement and the CPU determines that the state is a subject tracking enabled state, the tilt gimbal mode is set to the follow mode and the tilt gimbal sensitivity is set to high. Also, the CPU sets the pan gimbal mode to the follow mode and the pan gimbal sensitivity to medium. Also, the CPU sets the roll gimbal mode to the lock mode.

Specifically, in the case of tilt movement, the roll direction is preferably maintained at an angle with a direction perpendicular to the gravitational force as a reference. Here, the CPU sets the gimbal mode for the roll direction to the lock mode. Since the CPU has determined that subject tracking is enabled, it is expected that the user is capturing images of a subject while tracking the subject. Here, to make it easier for the user to track the subject, the CPU sets the gimbal mode for both tilt and pan to the follow mode. Also, since there is subject movement in conjunction with the tilt movement, it is expected that the subject will move in the up-down direction. Thus, the CPU increases the tilt gimbal sensitivity to increase the degree of tracking of the camera unit 101 with respect to the rotational movement about the tilt axis of the grip unit 102. Also, since the CPU has determined that subject tracking is enabled, it is expected that there will be many scenes in which the subject moves greatly in the left-right direction. Regarding this, the CPU can achieve both anti-shake and a degree of tracking of the camera unit 101 with respect to the rotational movement of the grip unit 102 by setting the pan gimbal sensitivity to medium. Such a setting is illustrated in column (H) of the table of FIG. 10.

(I) In a case where the CPU determines that the angular movement of the grip unit 102 is tilt movement and the CPU determines that the state is a subject tracking disabled state, the tilt gimbal mode is set to the follow mode and the tilt gimbal sensitivity is set to high. Also, the CPU sets the pan gimbal mode to the follow mode and the pan gimbal sensitivity to low. Also, the CPU sets the roll gimbal mode to the lock mode.

Specifically, as opposed to column (H), in a case where the pan gimbal sensitivity is set to low but there is tilt movement with subject tracking disabled, it is expected that there will be many scenes in which the user wants to stabilize vibration about the pan axis and control shaking for image capture. Regarding this, the CPU increases the anti-shake performance about the pan axis by setting the pan gimbal sensitivity to low. Such a setting is illustrated in column (I) of the table of FIG. 10.

(J) In a case where the CPU determines that the angular movement of the grip unit 102 is pan movement and the CPU determines that the state is a subject tracking enabled state, the tilt gimbal mode is set to the follow mode and the tilt gimbal sensitivity is set to medium. Also, the CPU sets the pan gimbal mode to the follow mode and the pan gimbal sensitivity to high. Also, the CPU sets the roll gimbal mode to the lock mode.

Specifically, in the case of pan movement, the roll direction is preferably maintained at an angle with a direction perpendicular to the gravitational force as a reference. Here, the CPU sets the gimbal mode for the roll direction to the lock mode. Also, since subject tracking is enabled, it is expected that the user will capture images of a subject while tracking the subject. Here, to make it easier for the user to track the subject, the CPU sets the gimbal mode for both tilt and pan to the follow mode. Also, since there is subject movement in conjunction with the pan movement, it is expected that the subject will move in the left-right direction. Regarding this, the CPU can increase the degree of tracking of the camera unit 101 with respect to the movement of the grip unit 102 by setting the pan gimbal sensitivity to high. Also, since subject tracking is enabled, it is expected that there will also be many scenes in which the subject moves greatly in the left-right direction. Regarding this, the CPU can achieve both anti-shake and a degree of tracking of the camera unit 101 with respect to the rotational movement about the tilt axis of the grip unit 102 by setting the tilt gimbal sensitivity to medium. Such a setting is illustrated in column (J) of the table of FIG. 10.

(K) In a case where the CPU determines that the angular movement of the grip unit 102 is pan movement and the CPU determines that the state is a subject tracking disabled state, the tilt gimbal mode is set to the follow mode and the tilt gimbal sensitivity is set to low. Also, the CPU sets the pan gimbal mode to the follow mode and the pan gimbal sensitivity to high. Also, the CPU sets the roll gimbal mode to the lock mode.

Specifically, as opposed to column (J), in a case where the tilt gimbal sensitivity is set to low but there is pan movement with subject tracking disabled, it is expected that there will be many scenes in which the user wants to stabilize the tilt axis and control shaking for image capture. Regarding this, the CPU increases the anti-shake about the tilt axis by setting the tilt gimbal sensitivity to low. Such a setting is illustrated in column (K) of the table of FIG. 10.

(L) In a case where the CPU determines that the angular movement of the grip unit 102 is pan and tilt movement and the CPU determines that the state is a subject tracking enabled state, the tilt gimbal mode is set to the follow mode and the tilt gimbal sensitivity is set to high. Also, the CPU sets the pan gimbal mode to the follow mode and the pan gimbal sensitivity to high. Also, the CPU sets the roll gimbal mode to the lock mode.

Specifically, in the case of tilt movement, the roll direction is preferably maintained at an angle with a direction perpendicular to the gravitational force as a reference. Here, the CPU sets the gimbal mode for the roll direction to the lock mode. Also, since subject tracking is enabled, it is expected that the user is capturing images of a subject while tracking the subject. Here, to make it easier for the user to track the subject, the CPU sets the gimbal mode for both tilt and pan to the follow mode. Also, since it is determined that the angular movement of the grip unit 102 is pan and tilt movement, it is expected that the subject is moving in a diagonal direction. Thus, the CPU sets both the pan gimbal sensitivity and the tilt gimbal sensitivity to high to increase the degree of tracking of the camera unit 101 with respect to the rotational movement about the pan axis and the tilt axis of the grip unit 102. Such a setting is illustrated in column (L) of the table of FIG. 10.

(M) In a case where the CPU determines that the angular movement of the grip unit 102 is pan and tilt movement and the CPU determines that the state is a subject tracking disabled state, the tilt gimbal mode is set to the follow mode and the tilt gimbal sensitivity is set to medium. Also, the CPU sets the pan gimbal mode to the follow mode and the pan gimbal sensitivity to medium. Also, the CPU sets the roll gimbal mode to the lock mode.

Specifically, as opposed to column (L), the gimbal sensitivity is set to medium for both tilt and pan. In the case of pan and tilt movement with subject tracking disabled, both anti-shake and a degree of tracking of the camera unit 101 with respect to the movement of the grip unit 102 can be achieved by setting the gimbal sensitivity of both the pan and tilt axis to medium. Such a setting is illustrated in column (M) of the table of FIG. 10.

(N) In a case where the CPU determines that the angular movement of the grip unit 102 is roll direction movement, the CPU sets the tilt gimbal mode to the lock mode, sets the pan gimbal mode to the lock mode, and sets the roll gimbal mode to the follow mode. Also, by setting the roll gimbal sensitivity to medium, the CPU increases the degree of tracking of the camera unit 101 with respect to the rotational movement about the roll axis of the grip unit 102 and obtains stable anti-shake performance for rotational movement about the other axes. Such a setting is illustrated in column (N) of the table of FIG. 10.

Now we will return to the description of the flowchart of FIG. 8. Via the method described above, in S803, the CPU automatically performed gimbal setting of each axis. Then, the processing advances to S406 of the flowchart of FIG. 4.

Note that in the present embodiment, in the case of rotational movement only about the pan axis or rotational movement only about the tilt axis, the pan and tilt gimbal mode are set to the follow mode. However, the pan and tilt (diagonal direction) determination threshold may be adjusted. Also, in a case where the CPU determines that the angular movement of the grip unit 102 is only about the pan axis, the tilt gimbal mode may be set to the lock mode. Also, in a case where the CPU determines that the angular movement of the grip unit 102 is only about the tilt axis, the pan gimbal mode may be set to the lock mode. Via such settings, the movement about the axes other than the rotational movement direction can be made more stable for image capture.

Also, in a case where the movement path reliability is set low in the movement path detection processing, the tracking state reliability is set low in the subject tracking state detection processing, or the like, the CPU may not perform automatic setting of the gimbal as illustrated in FIGS. 9 and 10. The CPU may use the default gimbal settings (for example, for the tilt gimbal mode, follow mode and medium gimbal sensitivity, for the pan gimbal mode, follow mode and medium gimbal sensitivity, and for the roll gimbal mode, lock mode).

Also, in a case where an angular movement state with rapid changes is continuously detected in the movement path detection processing, the tilt, pan, and roll gimbal mode may be set to the follow mode and each gimbal sensitivity may be set to high. With such gimbal settings, image capture tracking the user operation can be achieved.

Also, for example, in dark scenes, scenes with very large movement, and the like, it is plausible that the subject detection accuracy and the vector detection accuracy are decreased. In such cases, there is a possibility that a false determination occurs in the movement path detection processing and the subject tracking state detection processing, which may in turn affect the camera work settings (gimbal mode setting and gimbal sensitivity setting). Regarding this, the CPU may display a screen that allows the user to confirm matters relating to the set camera work on the display unit 220 (for example, a touch panel).

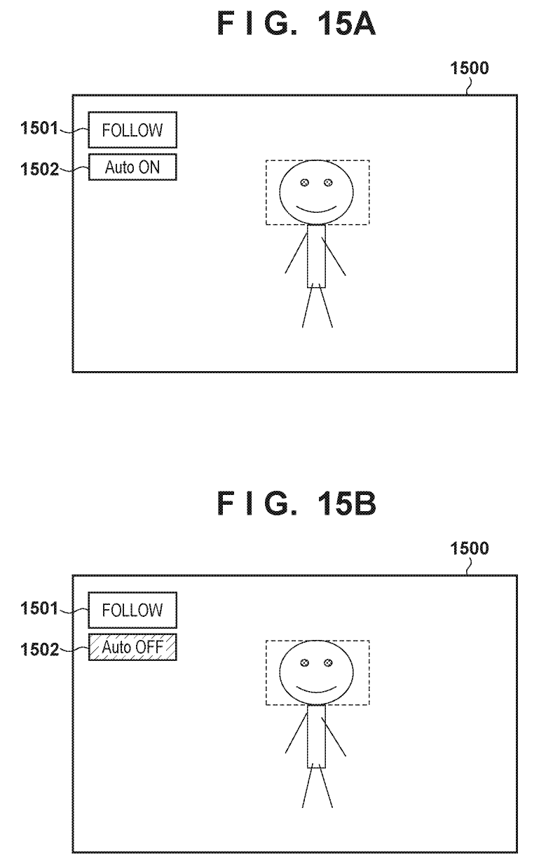

A live view screen 1500 that allows the user to confirm the result of the subject tracking state detection processing corresponding to the set camera work will now be described using FIGS. 15A and 15B. FIGS. 15A and 15B illustrate an example of the live view screen 1500 in a case where the CPU does not determine the angular movement of the grip unit 102 and determines that the translation movement direction is to the front-rear. The live view screen 1500 includes an object 1501 indicating the result of the subject tracking state detection processing. Note that the object 1501 in FIGS. 15A and 15B displays a character string (for example, “Follow”) indicating the subject tracking enabled state (the state of column (A) of the table of FIG. 9). Via the object 1501, the user can immediately confirm the content relating to the set camera work. Note that instead of the object 1501, an icon that allows the user to confirm the content of the camera work may be displayed.

Also, the live view screen 1500 includes an object 1502 that allows selection of manual mode or auto mode for the gimbal mode. FIG. 15A illustrates an example of the live view screen 1500 in a case where the gimbal mode is set to auto mode. FIG. 15B illustrates an example of the live view screen 1500 in a case where the gimbal mode is set to manual mode.

The user can immediately change the gimbal mode to manual mode by performing a touch operation on the touch panel while confirming the object 1501. Such an operation of the live view screen 1500 can help prevent an inappropriate gimbal setting being automatically set due to a false determination in the movement path detection or the subject tracking state detection. Thus, a situation in which an appropriate gimbal anti-shake control cannot be performed can be immediately avoided. Note that in a case where the auto mode is set to off, the CPU may change the gimbal setting to the setting information set in the manual mode settings of FIGS. 5A and 5B in advance. Alternatively, the CPU may store a plurality of preset gimbal settings in the memory in advance and may change the gimbal settings in response to detection of a number of touches by the user to one of the settings from among the plurality of gimbal settings.

### Advantages and Effects of Aspect

According to the gimbal camera 100 as described above, as illustrated in FIGS. 9 and 10, the gimbal control mode is automatically set in response to the movement path of the grip unit 102 and the subject tracking state. Also, in a case where the gimbal control mode is the follow mode, the gimbal sensitivity is automatically set into one of three levels. Thus, the user does not need to select the gimbal control mode and the gimbal sensitivity. This reduces the burden on the user. Also, the gimbal control mode being automatically set helps prevent the user from missing an image capture opportunity. Also, the gimbal control mode and the gimbal sensitivity can be set in response to the image capturing scene in order to achieve smooth video capture.

### First Modification Example

Next, the first modification example will be described. In the first modification example, gimbal settings including the tracking position of the grip unit 102, tracking speed, and the like are also automatically set.

Automatic Setting of Setting Value for each Camera Work used in Pan and Tilt Follow Control

In the first modification example, in S802 of the flowchart of FIG. 8 according to the embodiment described above, the CPU determines that it is camera work in conjunction with translation movement of the grip unit 102. Also, in a case where the CPU determines that the subject is in a tracked state in S705 of the flowchart of FIG. 7, as illustrated in (A), (C), and (E) of the table of FIG. 9, pan and tilt are set to the follow mode (also referred to as pan and tilt follow). In such a case, setting information is additionally set.

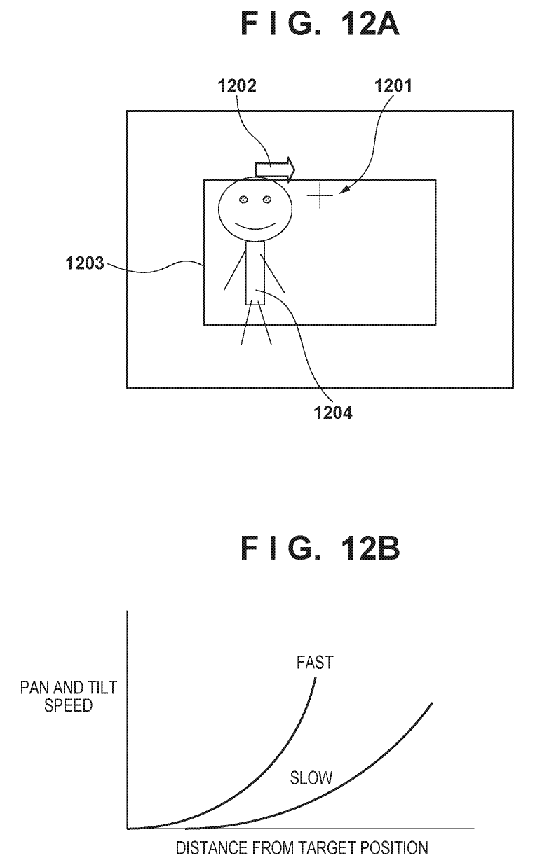

Three pieces of setting information set when pan and tilt follow control is performed will now be described using FIGS. 12A and 12B. FIG. 12A illustrates an example of the positional relationship between a target position and the subject. A target position 1201 illustrated in FIG. 12A indicates the target position 1201 of a subject 1204 when pan and tilt follow is being performed. Also, the length of an arrow 1202 illustrated in FIG. 12A represents the gradient of the speed curve of the pan and tilt speed. Note that in FIG. 12A, the target position 1201 is displayed as a “+” , but the type of symbol is not limited, and a symbol such as an “○” or “×” may be used.

The speed curve of the pan and tilt speed will now be described using FIG. 12B. The speed curve of the pan and tilt speed illustrates an example of the relationship between the distance from the target position to the subject and the pan and tilt speed, using a coefficient of the follow speed as a parameter. As illustrated in FIG. 12B, the pan and tilt speed increases as the distance between the subject 1204 and the target position 1201 increases. Also, when the speed coefficient is small, the pan and tilt speed decreases, and when the speed coefficient is large, the pan and tilt speed increases.

In a case where the pan and tilt speed is slow, the subject 1204 smoothly moves close to the target position 1201. On the other hand, in a case where the pan and tilt speed is fast, the subject 1204 swiftly returns to the target position 1201, but rapid image change tends to occur. Regarding this, for example, in a case where there is a possibility that the subject 1204 goes out from the field of view, the speed coefficient is set so that the pan and tilt speed is increased.

Also, a region 1203 illustrated in FIG. 12A indicates a region (margin region) where pan and tilt control is not performed even if the subject 1204 leaves the target position 1201. Note that in a case where the region 1203 is narrow, if the subject leaves the target position 1201 by a small amount, pan and tilt control is performed. Thus, rapid image change tends to occur and the captured video tends to be blurry. Accordingly, the region 1203 is set to be narrow in the case of tracking a subject for which the position in the video is important and set to be broad in other cases to avoid rapid image change.

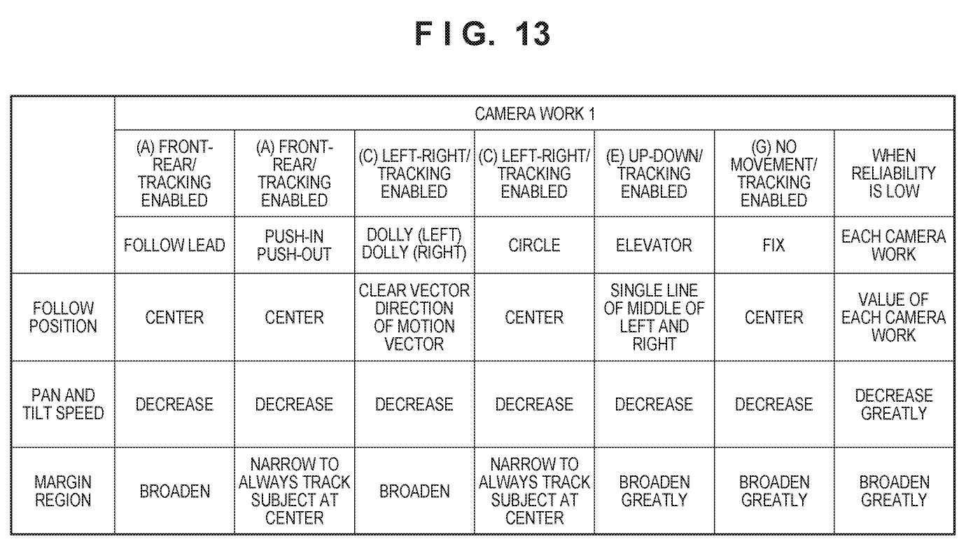

Three pieces of setting information set when pan and tilt follow control is performed will now be described using FIG. 13. The three pieces of setting information include information of the subject follow position, the pan and tilt speed, and the margin region for each camera work indicated by (A), (C), (E), and (G) in the table of FIG. 9, for example.

In the case of column (A) of FIG. 9, for the camera work follow mode, two types “Follow/lead” and “Push in/push out” can be selected. Specifically, “Follow/lead” is selected for image capture in which the size of the face of the subject is kept substantially constant. “Push in/push out” is selected for image capture in which the size of the face of the subject is made equal to or greater than a certain size.

In the case of “Follow/lead”, the follow position is set to “Center”. Also, the settings of column (A) of FIG. 9 are settings for camera work in which the subject rarely leaves the field of view. Thus, to avoid rapid image changes, the follow speed coefficient is set to a small value as with “Decrease” for the pan and tilt speed. Also, the margin region is set to “Broaden”.

In the case of “Push in/push out”, the follow position is set to “Center”. Also, regarding the pan and tilt speed, since the settings in column (A) of FIG. 9 are settings for camera work in which the subject rarely leaves the field of view, to avoid rapid image changes, the follow speed coefficient is set to a small value as with “Decrease” for the pan and tilt speed. Also, the margin region is set to “Narrow to always track subject at center”.

Also, in the case of column (C) of FIG. 9, “Dolly (left)/dolly (right)” or “Circle” can be selected for the camera work mode. Specifically, in a case where the absolute value of the detection value for the yaw rotation angle speed output from the angular velocity meter 104 is equal to or less than a predetermined value, “Dolly (left)/dolly (right)” is selected. Otherwise, “Circle” is selected.

In the case of “Dolly (left)/dolly (right)”, the follow position is set to “Clear the vector direction of the motion vector” as a composition in which the direction in which the subject is heading is clear is preferable. Also, as it is expected that without following the subject will often leave the field of view, the follow speed coefficient is set to a large value so that the pan and tilt speed is set to “Increase”. Since the position of the subject tends to constantly change in the field of view, the margin region is set to “Broaden”. Such a setting can help avoid rapid image changes.

In the case of “Circle”, the follow position is set to “Center”. Also, regarding the pan and tilt speed, since the settings in column (C) of FIG. 9 are settings for camera work in which the subject rarely leaves the field of view, to avoid rapid image changes, the follow speed coefficient is set to a small value as with “Decrease” for the pan and tilt speed. For camera work in which the user wishes for the subject to always be tracked in the center, the margin region is set to “Narrow”.

Also, in the case of column (E) of FIG. 9, the camera work mode is set to “Elevator”. In the case of “Elevator”, the follow position is “A left-right center line” instead of a single point as with “Center”, for example. Also, the follow speed coefficient is set to a small value as with “Decrease” for the pan and tilt speed. Since the position of the subject tends to constantly change in the up-down direction, the margin region is set to “Broaden greatly”. Such a setting can help avoid rapid image changes.

Also, in the case of column (G) of FIG. 9, the camera work is set to “Fix”. In the case of “Fix”, the follow position is set to “Center”. Also, the follow speed coefficient is set to a large value as with “Increase” for the pan and tilt speed. Also, the margin region is set to “Broaden greatly” since the movement of the subject cannot be predicted. Such a setting can help avoid rapid image changes.

Also, in a case where the movement path reliability calculated in S607 or the tracking state reliability calculated in S703 is low, there is a possibility of a false determination in the movement path detection or the subject tracking state detection. For this, the CPU sets in advance a threshold for the movement path reliability and the tracking state reliability. Also, in a case where the CPU determines that at least one of these reliabilities is less than the threshold, the camera work is determined to be due to the result of a false determination. The follow position is set to a value for each camera work. Also, the follow speed coefficient is set to a very small value as with “Decrease greatly” for the pan and tilt speed. Also, the margin region is set to “Broaden greatly”.

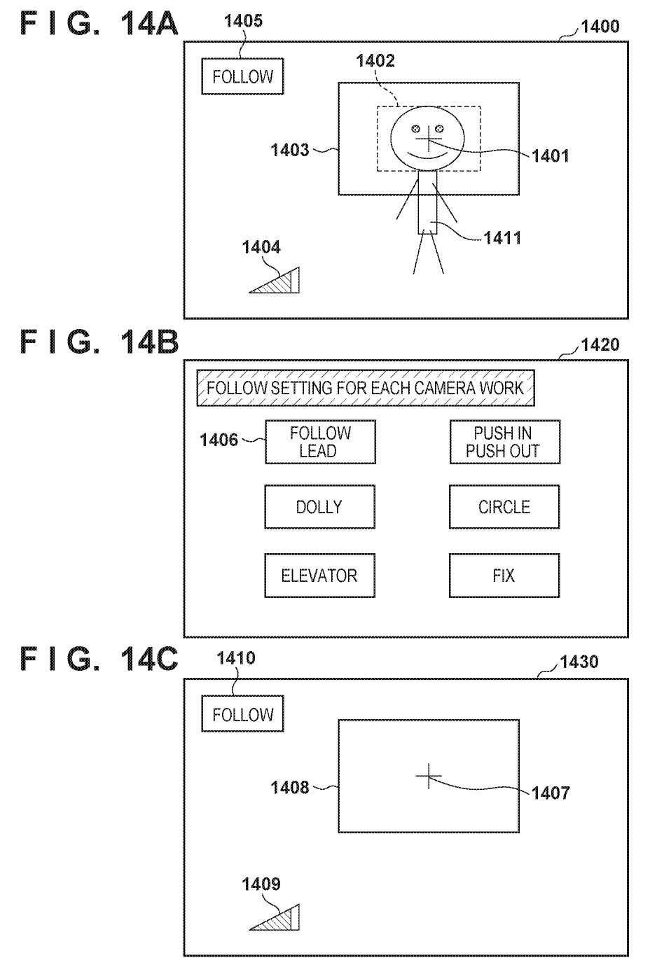

A display screen relating to the follow position, pan and tilt speed, and margin region according to the first modification example will now be described using FIGS. 14A to 14C. FIG. 14A illustrates an example of a display screen 1400 including the follow position, pan and tilt speed, and margin region used when performing pan and tilt follow control.

The display screen 1400 includes objects 1401 to 1405. The object 1401 indicates the target position of the follow position illustrated in FIG. 13. The CPU receives a drag operation of the object 1401 and displays the object 1401 at a different position. The object 1402 indicates a face frame of a subject 1411. In other words, in a case where the CPU determines that person detection is enabled in S701 of FIG. 7, the CPU displays the object 1402. The CPU receives a drag operation of the object 1402 and displays the object 1402 at a different position.

The object 1403 indicates a frame of the margin region. The CPU receives a drag operation of the object 1403 and displays the object 1403 with its size scaled up or down. The object 1404 is an icon for adjusting the pan and tilt speed. The CPU receives a drag operation of the object 1404 and changes the follow speed coefficient that determines the pan and tilt speed. In other words, the follow speed coefficient is decreased when the user drags the object 1404 to the left, and the follow speed coefficient is increased when the user drags the object 1404 to the right. Also, the object 1405 is an object indicating that the determined camera work is pan and tilt follow.

A settings screen 1420 that allows three setting values, the follow position, the pan and tilt speed, and the margin region, to be changed will now be described using FIGS. 14B and 14C. As illustrated in FIG. 14B, the settings screen 1420 includes an object 1406 for selecting the follow mode of the camera work. When a touch operation of the object 1406 is received, the CPU receives a selection of the follow mode of the camera work. Then, the CPU transitions the screen to a settings screen 1430 illustrated in FIG. 14C.

The settings screen 1430 that allows three setting values to be set for each follow mode of the camera work will now be described using FIG. 14C. The settings screen 1430 includes objects 1407 to 1410. The objects 1407 to 1410 have a similar function to the objects 1401, 1403, 1404, and 1405 in FIG. 14A. When the user operates the settings screen 1420 and the settings screen 1430, the initial values of each camera work can be set.

### Advantages and Effects of Aspect

According to the gimbal camera 100 according to the first modification example, effects similar to the effects according to the embodiment can be achieved. In addition, in a case where it is detected that the subject is being tracked, by the gimbal control mode and the control parameters being automatically set as illustrated in FIG. 13, the subject can be tracked while being kept in the display screen. This reduces the burden on the user to capture a smooth video.

### Other Modification Examples

The gimbal control mode and the control parameters of gimbal control may be automatically changed during image capture. For example, during video capture, detection processing for the tracking state of the subject illustrated in FIG. 7 may be periodically executed. Also, in a case where the tracking state changes from “tracked” to “not tracked”, the gimbal control mode and the gimbal sensitivity may be automatically changed from column (A) to column (B) illustrated in FIG. 9. Also, during the tracking of a subject, for example, the distance between the subject 1204 and the target position 1201 may be periodically measured. In a case where the distance between the subject 1204 and the target position 1201 continues to correspond to a deviated state, the pan and tilt speed may be set to be automatically increased.

Also, in the embodiment described above, the gimbal camera 100, the camera unit 101, the gimbal unit 103, and the grip unit 102 are integrally formed, but the camera unit 101, the gimbal unit 103, and the grip unit 102 may each be separately formed. Also, the camera unit 101 may be able to be attached to and detached from the gimbal unit 103. Specifically, the camera unit 101 may be a smartphone installed with a camera, for example. Also, the gimbal unit 103 may be provided with a holder mechanism that can secure a smartphone in the up-down direction and the left-right direction via a spring system, for example. According to such a configuration, the smartphone can be attached to and detached from the gimbal unit 103. Also, the driving force about each axis of the motor of the gimbal unit 103 can be transferred to the mounted smartphone. Also, the control unit 216 and the like may be provided on the gimbal unit 103. Captured image data and the like may be wirelessly communicated between the camera unit 101 and the control unit 216 or the like.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-011657, filed January 27, 2025, which is hereby incorporated by reference herein in its entirety.

What is claimed is:

1. An image capture apparatus comprising:
an image capture unit that captures an image of a subject;
a support unit that supports the image capture unit;
a gimbal unit that connects the image capture unit and the support unit and can control tracking of the image capture unit relative to movement of the support unit;
one or more memory devices that store a set of instructions; and
one or more processors that execute the set of instructions to:
automatically set a predetermined control mode from among a plurality of control modes for controlling the tracking.

2. The image capture apparatus according to claim 1, wherein
the movement of the support unit is translation movement and rotational movement,
the translation movement is movement in each of a front-rear direction which is a horizontal direction from the support unit toward the subject, a left-right direction which is a horizontal direction orthogonal to the front-rear direction, and an up-down direction orthogonal to both the front-rear direction and the left-right direction, and
the rotational movement is rotational movement about each of a tilt axis, a pan axis, and a roll axis.

3. The image capture apparatus according to claim 2, wherein
the plurality of control modes include
a first control mode in which the image capture unit is controlled to track rotation of the support unit, and
a second control mode in which the image capture unit is controlled to not track rotation of the support unit,
the gimbal unit includes a motor having each of the tilt axis, the pan axis, and the roll axis as a rotation axis, and
the one or more processors execute instructions in the one or more memory devices to:
set one of the first control mode and the second control mode for each of rotation about the tilt axis, rotation about the pan axis, and rotation about the roll axis.

4. The image capture apparatus according to claim 3, wherein
the one or more processors further execute instructions in the one or more memory devices to:
determine whether rotation of the support unit occurred,
in a case where it was determined that rotation of the support unit occurred, set the predetermined control mode for each of the rotation about the tilt axis, the rotation about the pan axis, and the rotation about the roll axis, and
in a case where it was determined that rotation of the support unit did not occur, determine whether translation movement of the support unit occurred for each of the front-rear direction, the left-right direction, and the up-down direction, and
set the predetermined control mode for each of the rotation about the tilt axis, the rotation about the pan axis, and the rotation about the roll axis according to a result of this determination of translation movement.

5. The image capture apparatus according to claim 4, wherein
the one or more processors further execute instructions in the one or more memory devices to:
detect movement of the support unit,
detect a tracking state of the subject via the image capture unit using a result of this detection of movement of the support unit, and
set the predetermined control mode according to a result of the detection of movement of the support unit and this detection of the tracking state.

6. The image capture apparatus according to claim 5, wherein
the image capture unit further includes an angular velocity sensor and an acceleration sensor, and
the one or more processors execute instructions in the one or more memory devices to:
calculate a translation movement amount and a rotational movement amount of the image capture unit using a displacement vector of the subject, an output of the angular velocity sensor, and an output of the acceleration sensor, and
calculate a movement amount of the support unit using the translation movement amount and the rotational movement amount of the image capture unit that were calculated and a rotation angle of the motor.

7. The image capture apparatus according to claim 6, wherein
the one or more processors execute instructions in the one or more memory devices to:
detect the tracking state using a first determination result indicating whether the subject is included in captured image data captured by the image capture unit, a second determination result indicating whether the subject is identical to a previously detected subject, a reliability of the second determination result, and a reliability of detection of movement of the support unit.

8. The image capture apparatus according to claim 3, wherein
the image capture unit further includes an angular velocity sensor and either an acceleration sensor or a geomagnetic sensor,
in the first control mode, the gimbal unit controls the rotation using an output of the angular velocity sensor, and
in the second control mode, the gimbal unit controls the rotation using an output of the angular velocity sensor and an output of either the acceleration sensor or the geomagnetic sensor.

9. The image capture apparatus according to claim 3, wherein
the one or more processors further execute instructions in the one or more memory devices to:
set a control parameter of the first control mode, and wherein
the control parameter of the first control mode includes a degree of tracking of rotation of the image capture unit with respect to rotation of the support unit about each of the tilt axis, the pan axis, and the roll axis.

10. The image capture apparatus according to claim 9, wherein
the plurality of control modes include a third control mode relating to tracking of the subject, and wherein
the one or more processors further execute instructions in the one or more memory devices to:
set the third control mode, and wherein
a control parameter of the third control mode includes
a target position of the subject on a display screen,
a degree of tracking of each of the rotation about the tilt axis and the rotation about the pan axis, and
a region that includes the subject and is a region for which the image capture unit does not track rotation of the support unit in a case where the subject deviates from the target position.

11. The image capture apparatus according to claim 10, further comprising
a display unit that displays a first screen including
the subject captured by the image capture unit,
the predetermined control mode that was set, and
a first object for selecting whether the predetermined control mode is to be set automatically or manually.

12. The image capture apparatus according to claim 11, wherein
the display unit further displays a second screen including
a second object for selecting whether the predetermined control mode is to be set automatically or manually,
a third object for, in a case where the predetermined control mode is set manually, selecting a control mode for each of the tilt axis, the pan axis, and the roll axis, and
a fourth object for, in a case where the control mode selected by an operation performed on the third object is the first control mode, selecting adjustment of the control parameter of the first control mode, and wherein
the display unit further displays a third screen including a fifth object for, in a case where the fourth object on the second screen is selected, adjusting the control parameter of the first control mode.

13. The image capture apparatus according to claim 11, wherein
the display unit further displays a fourth screen including
the third control mode that was set,
the subject captured by the image capture unit,
a symbol for selecting a target position of the subject for when the subject is tracked,
a first frame for moving the subject,
a second frame for selecting a region that includes the subject and is a region for which the image capture unit does not track rotation of the support unit in a case where the subject deviates from the target position, and
a sixth object for selecting a degree of tracking of the image capture unit relative to rotation of the support unit.

14. The image capture apparatus according to claim 13, wherein
the display unit further displays a fifth screen including a seventh object for selecting the third control mode, and
in a case where the seventh object on the fifth screen was selected, the display unit further displays a sixth screen including
the third control mode selected by an operation performed on the seventh object,
the symbol,
the second frame, and
the sixth object.

15. A control method for an image capture apparatus comprising:
controlling tracking of an image capture unit, which captures an image of a subject, relative to movement of a support unit that supports the image capture unit; and
automatically setting a predetermined control mode from among a plurality of control modes for controlling the tracking.

16. A non-transitory computer-readable storage medium storing a computer program for causing a computer to execute a control method for an image capture apparatus, the method comprising:
controlling tracking of an image capture unit, which captures an image of a subject, relative to movement of a support unit that supports the image capture unit; and
automatically setting a predetermined control mode from among a plurality of control modes for controlling the tracking.
